(19) United States
(12) Patent Application Publication
(10) Pub. No.: US 2016/0201347 A1
(43) Pub. Date: Jul. 14, 2016

(54) Self-Serve Food and Beverage Service

(71) Applicant: Fauzia Lala, Redmond, WA (US)

(72) Inventor: Fauzia Lala, Redmond, WA (US)

(21) Appl. No.: 14/595,945

(22) Filed: Jan. 13, 2015

(51) Int. Cl. E04H 3/04; G06Q 50/12; A23L 1/29

(52) U.S. Cl. CPC E04H 3/04; A23L 1/293; G06Q 50/12; A23V 2002/00

(57) ABSTRACT

An enclosed food and beverage stand may allow customers to create and purchase fresh and customizable self-serve refreshments such as whole fruit and vegetable smoothies, bubble teas, milkshakes, and baby food purees, for example. The stand may be installed in high pedestrian traffic areas such as transit centers, hiking trails, or parks, for example, and may utilize a secured access system for entry. A self-serve food and beverage service may use software which allows customers to input data such as dietary goals or preferred ingredients, to receive a tailored recipe. A self-serve food and beverage service may include a vending machine which dispenses fresh food and beverages and allows customers to conduct a single payment transaction for items dispensed from multiple machines.

### FIELD

This disclosure relates generally to a Self-Serve Food and Beverage Service.

### BACKGROUND

People often lack access to fresh and healthy food and beverages when they are on the go, for example, while waiting at a transit center or hiking on a trail. Refreshments sold by fast-food chains typically contain high fat, caloric, and sugar contents. Even blended beverages, such as smoothies, are typically made from powdered or frozen fruits or vegetables which have lost significant nutritional value. Packaged items, such as bottled juices and purees, often lose antioxidants, vitamins, minerals, and flavor during heating or pasteurization.

While traditional vending machines may provide a quick and easy means to buy snacks and drinks, they generally do not dispense and accept payment for freshly-blended and customizable refreshments such as whole fruit and vegetable smoothies, bubble teas, milkshakes, and pureed baby food, for example. Neither do traditional vending machines allow customers to tailor refreshments to their particular dietary needs by, for example, utilizing software to create customized products.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The instant application discloses, among other things, a Self-Serve Food and Beverage Service. In one embodiment, it may comprise an enclosed food and beverage building structure, where customers may themselves create and purchase fresh and customizable self-serve refreshments such as whole fruit and vegetable smoothies, bubble teas, milkshakes, and baby food purees, for example. The stand may be installed in high pedestrian traffic areas such as transit centers, hiking trails, or parks, for example, and may utilize a secured access system for entry. Self-Serve Food and Beverage Service may utilize software which allows customers to input data such as dietary goals or preferred ingredients, for example, to receive a tailored recipe suitable to a particular customer's needs.

In another embodiment, Self-Serve Food and Beverage Service may include a vending machine which dispenses fresh food and beverages, such as fruit and vegetable smoothies or ingredients, and allows customers to conduct a single payment transaction for items dispensed at separate machines. Payments may be made using cash, a credit or rewards card, tokens, or a mobile device, for example. In another embodiment, a method for packaging Self-Serve Food and Beverage Service ingredients may include a single package with dividers separating individual ingredients which together make up a standard recipe mix or sealed containers, such as plastic cups, containing ingredients. The sealed containers may be vacuum-sealed.

Many of the attendant features may be more readily appreciated as they become better understood by reference to the following detailed description considered in connection with the attached drawings.

### BRIEF DESCRIPTION OF THE DRAWINGS

FIG. 1 illustrates one example of a Self-Serve Food and Beverage Service stand, according to one embodiment.

FIG. 2 is a flow diagram illustrating a Self-Serve Food and Beverage Service method, according to one embodiment.

FIG. 3 illustrates one example of a standard recipe package containing individually-sealed ingredient packets, according to one embodiment.

FIG. 4 illustrates one example of a sealed container containing a standard recipe mix, according to one embodiment.

FIG. 5 illustrates one example of a user interface for a Self-Serve Food and Beverage Service computer application, according to one embodiment.

FIG. 6 illustrates one example of a user interface for a Self-Serve Food and Beverage Service computer application, according to another embodiment.

FIG. 7 illustrates one example of a Self-Serve Food and Beverage Service vending machine, according to one embodiment.

FIG. 8 is a block diagram illustrating one example of a system capable of supporting a Self-Serve Food and Beverage Service, according to one embodiment.

FIG. 9 is a component diagram of a computing device to which a Self-Serve Food and Beverage Service process may be applied according to one embodiment.

Like reference numerals are used to designate like parts in the accompanying drawings.

### DETAILED DESCRIPTION

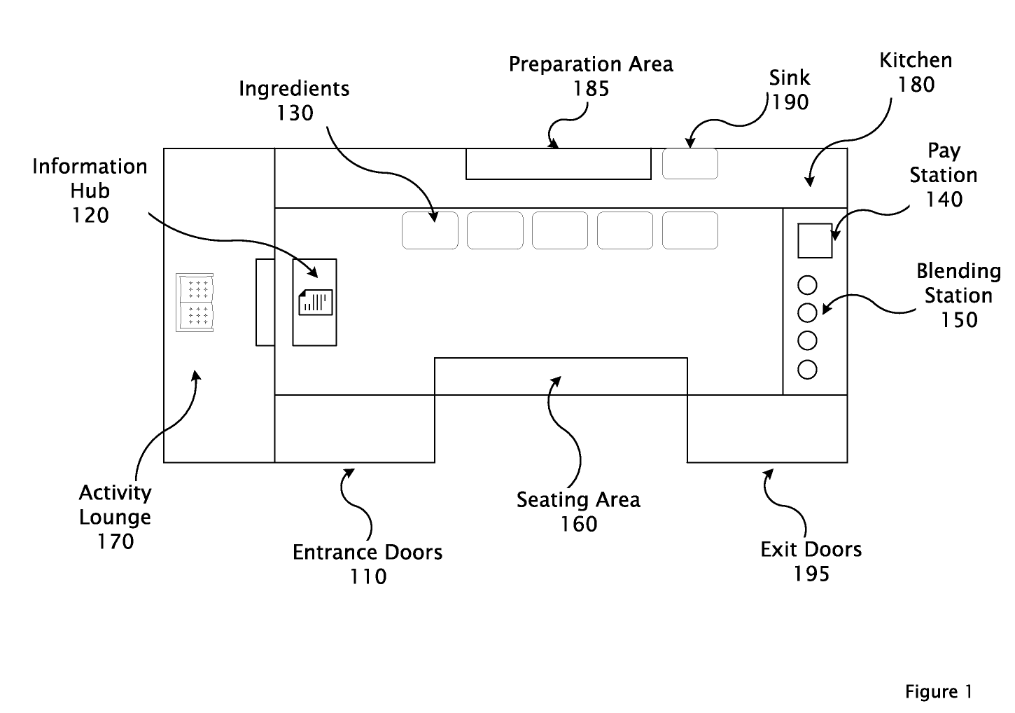

FIG. 1 illustrates one example of a Self-Serve Food and Beverage Service stand, according to one embodiment. In this example, a free-standing enclosed stand may be installed in a high pedestrian traffic area such as a transit center, hiking trail, or park, for example. The stand may have a roof and walls to protect equipment and customers from the weather, for example. In one embodiment, Self-Serve Food and Beverage stand may utilize a secured access system. For example, to gain access into the establishment, a customer may be required to perform an action such as swipe a credit card or membership card, or utilize a finger or iris scanner. The customer's name, order history, photo, and other information may then be stored in a database.

After gaining entry into the Self-Serve Food and Beverage stand and walking through Entrance Doors 110, for example, the customer may proceed to Information Hub 120 to review instructions, recipes, or ingredient information, which may be provided in a booklet, touch-screen computer, or mobile device. The customer may search for recipes or ingredients based on preferred ingredients, recipe names, health conditions or dietary restrictions, for example. Data may also be received directly from a customer's online health, fitness, or social profile, or from a customer's device such as a smartphone, health monitoring device, or wearable fitness tracker, for example. Data may also be obtained by a user directly, for example, by an on-site health detection device which may determine a customer's health condition or dietary needs by taking that customer's temperature, blood pressure, or blood sugar level, for example.

After receiving recommendations or selecting recipes or ingredients, the customer may proceed to Ingredients 130, which may be housed in housing units such as refrigerators or vending machines, for example. Ingredients 130 may include whole fruits and vegetables, grains, proteins, spices, dairy products, dairy alternatives, and other ingredients. Ingredients 130 may be packaged individually or grouped in a standard recipe mix package, which may, for example, include heat-sealed dividers separating individual ingredients. The customer may manually retrieve the desired ingredients, or the ingredients may be automatically dispensed. In another embodiment, the Ingredients 130 housing unit may have an integrated mixing or blending device and the final food or beverage product may be dispensed either automatically or manually from the housing unit.

According to one embodiment, Pay Station 140 may be built into a vending machine. In another embodiment, the customer may proceed to Pay Station 140 to pay by cash, credit card, rewards card, or tokens, for example, any time before, during, or after receiving the final food or beverage product. Pay Station 140 may also be integrated with the housing units, for example, refrigerators or vending machines, of Ingredients 130. A user may also pay by using a mobile device, such as a smart phone, for example, to make wireless payments through an online account or payment service. A customer may have the ability to conduct a single payment transaction for food and beverage items dispensed from separate refrigerators or vending machines, instead of having to conduct multiple transactions, which may be burdensome or costly due to credit card transaction fees, for example.

If a mixing or blending unit is not integrated within a vending machine or within the housing units of Ingredients 130, the customer may proceed to Blending Station 150 to combine the ingredients and create a desired food or beverage such as a smoothie, bubble tea, milkshake, or pureed baby food, for example. In one embodiment, Blending Station 150 may comprise at least one blender or mixer and have dimensions of approximately 1 foot by 4 feet, for example. The customer may add additional ingredients such as ice, dairy products, dairy alternatives, sweeteners, or garnishes, for example, at Blending Station 150. In one embodiment, recipes may use natural sweeteners such as dates and figs. In another embodiment, recipes may use honey as a natural sweetener. Blending Station 150 may utilize any type of blending or mixing devices and tools, and a user may use any container, such as a blender cup, including those that are disposable, reusable, recyclable, biodegradable, and self-cleaning, for example. In another embodiment, Blending Station 150 may be integrated in the housing units for Ingredients 130, for example, a blender may be included inside a vending machine.

In this example, Self-Serve Food and Beverage Service stand may include Seating Area 160 and Activity Lounge 170, which may include chairs, entertainment, and storage areas for personal belongings. It may also include a Kitchen 180 with a Preparation Area 185 and Sink 190, for example. The customer may then exit the Self-Serve Food and Beverage Service stand through Exit Doors 195. A person skilled in the art will understand that variations in configuration, such as layout and seating arrangements, may occur without departing from the spirit and scope of Self-Serve Food and Beverage Service.

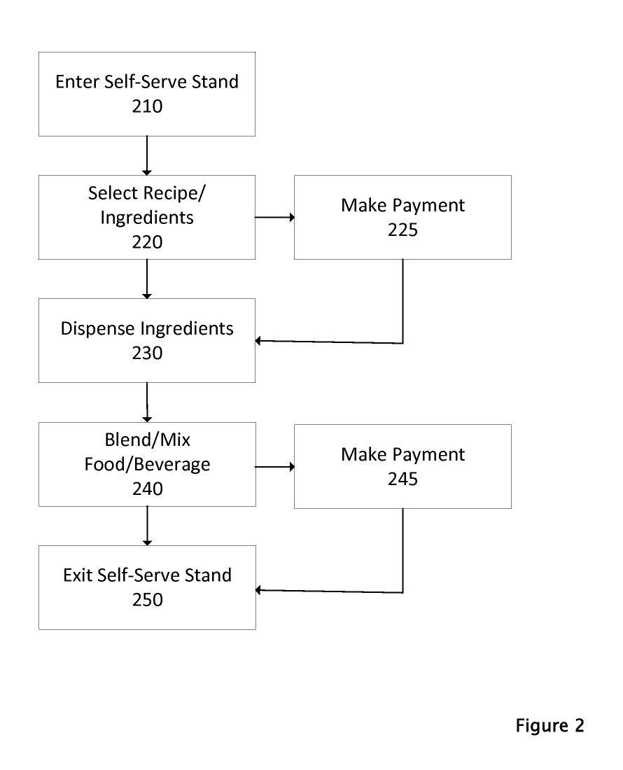

FIG. 2 is a flow diagram illustrating a Self-Serve Food and Beverage Service process, according to one embodiment. At Enter Self-Serve Stand 210, a customer may walk into the Self-Serve Food and Beverage Service stand. At Select Recipe/Ingredients 220, the customer may find recipes and ingredients using an informational booklet, viewing a website, or using a computer or mobile software application, for example. The customer may input data such as preferred ingredients, health conditions or dietary needs, or recipe names to receive recipe and ingredient recommendations suitable to that customer's needs. Data may also be received from a user's online profile, a mobile device, such as a smartphone, a health monitoring device, or a wearable fitness tracker, for example. The customer may make payment at any point during the Self-Serve Food and Beverage Service process, for example, at Make Payment 225 following the step of Select Recipe/Ingredients 220. Payment may also be made at Make Payment 245, for example, as discussed below.

At Dispense Ingredients 230, the customer may retrieve Ingredients 130 from a housing unit such as a refrigerator or vending machine, for example. At Blend/Mix Food/Beverage 240, the customer may combine Ingredients 130 to create a desired food or beverage product, such as a smoothie, bubble tea, milkshake, or pureed baby food, for example. This may be done by taking Ingredients 130 to Blending Station 150, or Ingredients 130 may blend within a housing unit such as a vending machine containing a mixing or blending device, for example. At Make Payment 245, the customer may, at any time during the Self-Serve Food and Beverage process, pay for the food and beverage items, for example, in a single transaction for multiple machines. The customer may then depart the Self-Serve Food and Beverage Service stand at Exit Self-Serve Stand 250.

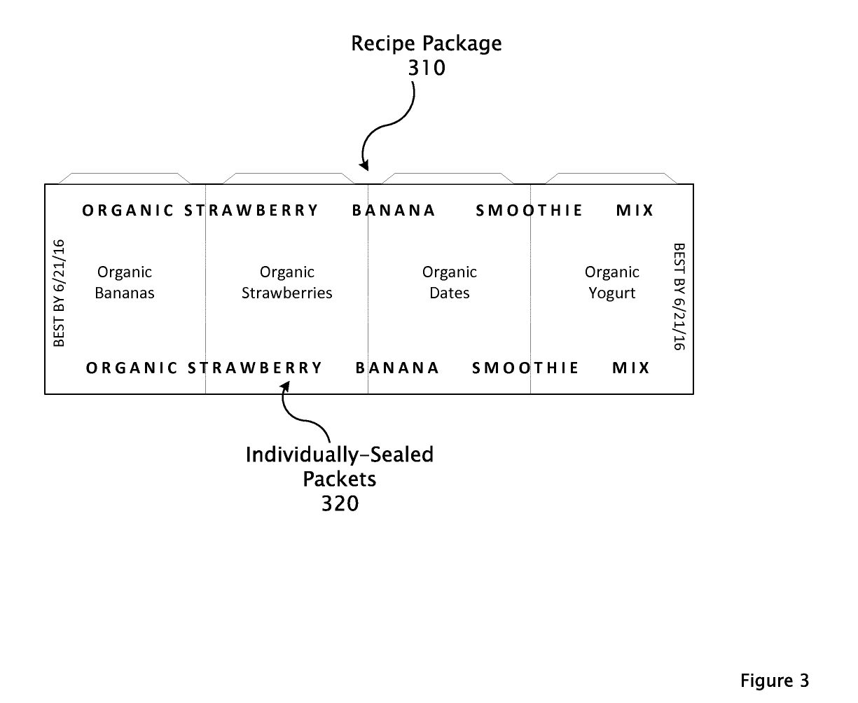

FIG. 3 illustrates one example of a standard recipe package containing Individually-Sealed Packets 320, according to one embodiment. In this example, Recipe Package 310 may comprise any recipe mix, such as an organic strawberry banana smoothie mix, for example. It may include Individually-Sealed Packets 320, which may be separated from other ingredients in the Recipe Package 310 by heat sealing, for example. Recipe Package 310 and Individually-Sealed Packets 320 may include tamper-proof enclosures and printed information such as expiration, sell by or use by dates, ingredient information, prices, and barcodes. In another embodiment, packaging may comprise ingredients piled and sealed inside plastic cups, for example. In yet another embodiment, packaging may involve vacuum sealing ingredients to help achieve compact storage and preserve freshness, for example.

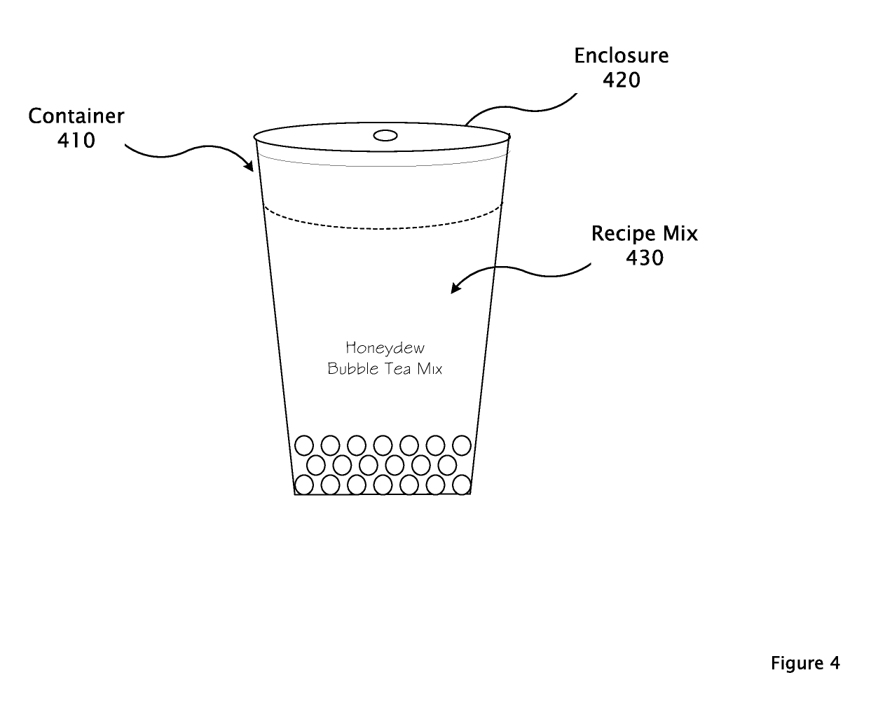

FIG. 4 illustrates one example of a sealed container containing standard Recipe Mix 430, according to one embodiment. In addition to Recipe Mix 430 packages and individual ingredients, Self-Serve Food and Beverage Service may dispense any Container 410, such as cups, bowls, jars, tubes, or pouches having an Enclosure 420 such as a lid, cap, seal, or zipper, containing any Recipe Mix 430, for example, a honeydew bubble tea mix or a pureed baby food. Container 410 may be made in any material, shape, color, and size and may have heat-resistant, airtight, light-resistant, temperature-controlled, spill-proof, leak-proof, disposable, recyclable, biodegradable, compostable, self-cleaning, BPA-free, and other characteristics.

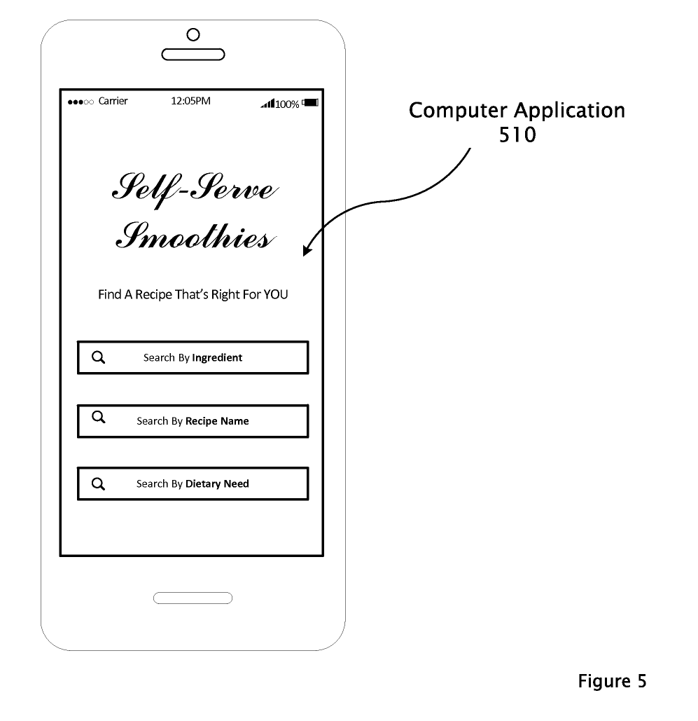

FIG. 5 illustrates one example of a user interface for a Self-Serve Food and Beverage Service computer application, according to one embodiment. In this example, Computer Application 510 may be installed on a mobile device such as a smartphone, laptop, tablet, smart watch, or intelligent eyewear, for example. It may include a screen which allows a customer to search for recipes based on an ingredient, recipe name, or dietary need, for example.

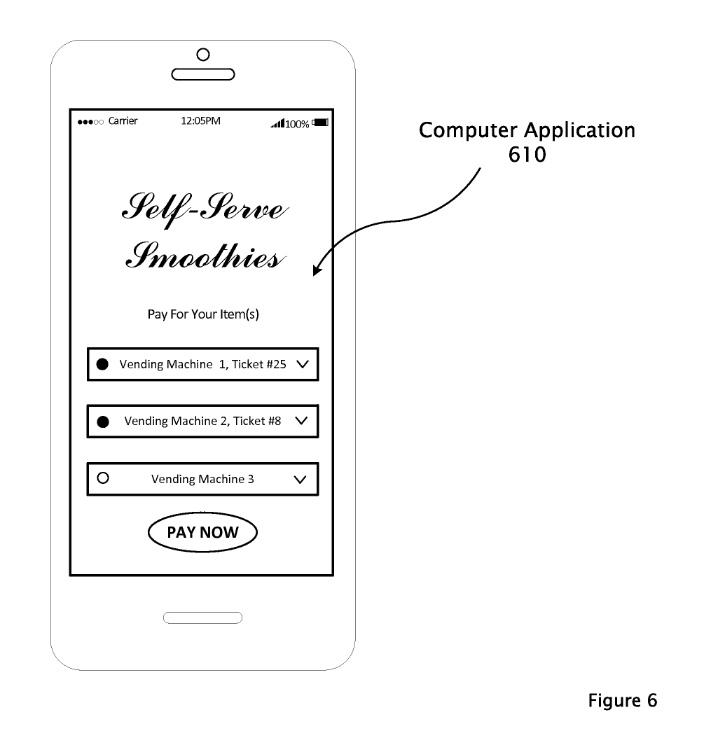

FIG. 6 illustrates one example of a user interface for a Self-Serve Food and Beverage Service computer application, according to another embodiment. In this example, Computer Application 610 may allow a customer to pay for items from a Self-Serve Food and Beverage Service on a mobile device. For example, the customer may pay for items dispensed from multiple vending machines by conducting a single payment transaction instead of having to make multiple transactions, which may be burdensome and costly to the customer or business, as many credit card and other payment systems providers charge per transaction.

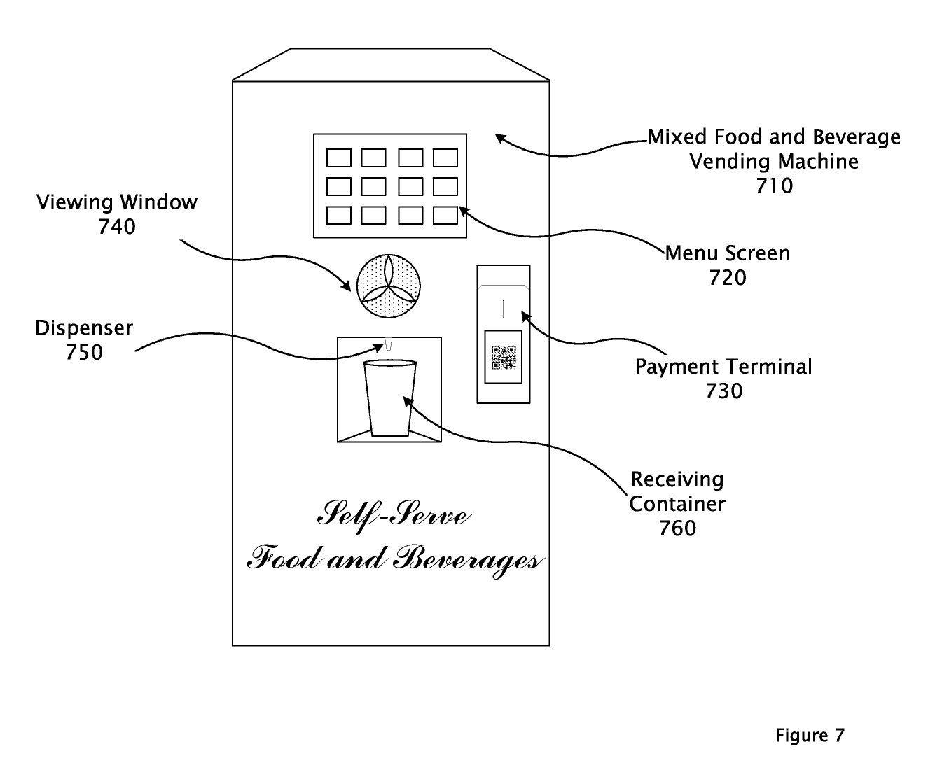

FIG. 7 illustrates one example of a Self-Serve Food and Beverage Service vending machine, according to one embodiment. In this example, Mixed Food and Beverage Vending Machine 710 may comprise a housing unit with a water supply, heating, and refrigeration system. It may include Menu Screen 720, upon which a customer may view recipe and ingredient information and make selections. The customer may also input information such as preferred ingredients, health conditions or dietary needs, and recipe names into Menu Screen to retrieve a recipes and ingredients list tailored to that particular customer's needs. The customer may also input information from an online account, health monitoring device, or wearable fitness tracker, for example, to receive customized recipe and ingredient information. At Payment Terminal 730, the customer may pay a single or multiple food or beverage items by cash, credit card, rewards card, tokens, or wireless payments through an online account or payment service, for example.

Mixed Food and Beverage Vending Machine 710 may also include a Viewing Window 740 which may show ingredients, such as whole fruits and vegetables, for example, being mixed or blended. Viewing Window 740 may also show ingredients moving down various compartments, tubes or slides, for example. The mixed food or beverage may exit through Dispenser 750 and into Receiving Container 760 such as a cup, bowl, jar, tube, or pouch, for example. The finished product may comprise any food or beverage item, for example, smoothies, milkshakes, baby purees, bubble teas, and juices.

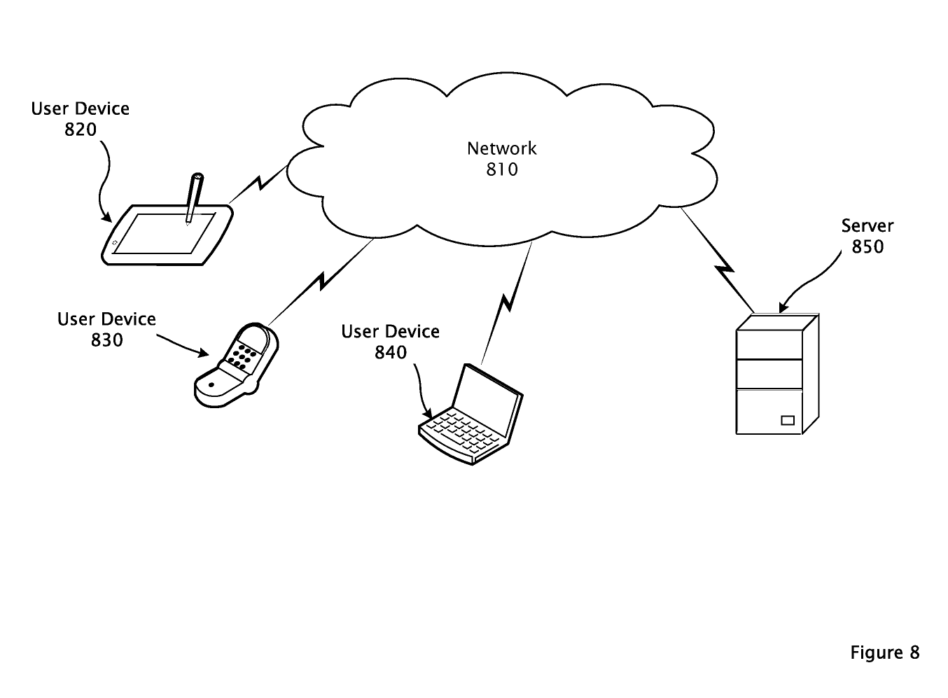

FIG. 8 is a block diagram illustrating one example of a system capable of supporting a Self-Serve Food and Beverage Service, according to one embodiment. Network 810 may include Wi-Fi, cellular data access methods, such as 3G or 4GLTE, Bluetooth, Near Field Communications (NFC), the Internet, local area networks, wide area networks, or any combination of these or other means of providing data transfer capabilities. In one embodiment, Network 810 may comprise Ethernet connectivity. In another embodiment, Network 810 may comprise fiber optic connections.

User Device 820, 830, 840 may be a smartphone, tablet, laptop computer, smart watch or intelligent eyewear, or other device, and may have network capabilities to communicate with Server 850. Server 850 may include one or more computers, and may serve a number of roles. Server 850 may be conventionally constructed or may be of a special purpose design for processing data obtained from Self-Serve Food and Beverage Service. One skilled in the art will recognize that Server 850 may be of many different designs and may have different capabilities. For example, Server 850 may control Mixed Food and Beverage Vending Machine 710, may allow for payments to be made, or may provide any other services for Self-Serve Food and Beverage Service.

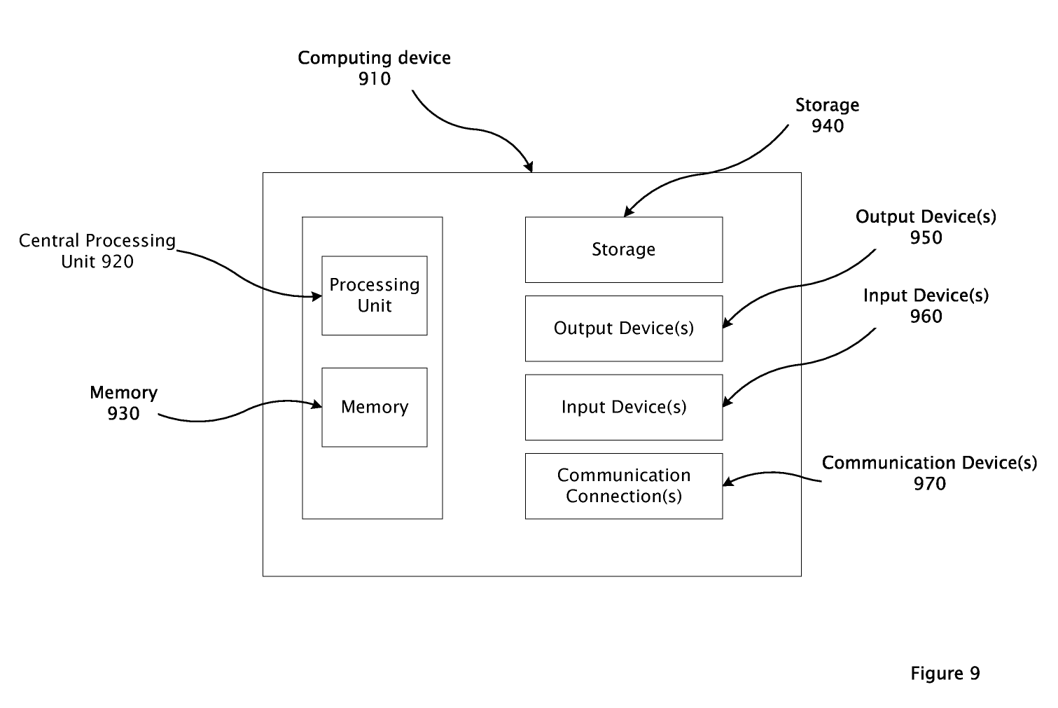

FIG. 9 is a component diagram of a computing device to which a Self-Serve Food and Beverage Service process may be applied according to one embodiment. The Computing Device 910 can be utilized to implement one or more computing devices, computer processes, or software modules described herein, including, for example, but not limited to a mobile device. In one example, the Computing Device 910 can be used to process calculations, execute instructions, and receive and transmit digital signals. In another example, the Computing Device 910 can be utilized to process calculations, execute instructions, receive and transmit digital signals, receive and transmit search queries and hypertext, and compile computer code suitable for a mobile device. The Computing Device 910 can be any general or special purpose computer now known or to become known capable of performing the steps and/or performing the functions described herein, either in software, hardware, firmware, or a combination thereof.

In its most basic configuration, Computing Device 910 typically includes at least one Central Processing Unit (CPU) 920 and Memory 930. Depending on the exact configuration and type of Computing Device 910, Memory 930 may be volatile (such as RAM), non-volatile (such as ROM, flash memory, etc.) or some combination of the two. Additionally, Computing Device 910 may also have additional features/functionality. For example, Computing Device 910 may include multiple CPU's. The described methods may be executed in any manner by any processing unit in Computing Device 910. For example, the described process may be executed by both multiple CPU's in parallel.

Computing Device 910 may also include additional storage (removable or non-removable) including, but not limited to, magnetic or optical disks or tape. Such additional storage is illustrated in FIG. 4 by Storage 940. Computer readable storage media include volatile and nonvolatile, removable and non-removable media implemented in any method or technology for storage of information such as computer-readable instructions, data structures, program modules or other data. Memory 930 and Storage 940 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by Computing Device 910. Any such computer-readable storage media may be part of Computing Device 910. But computer-readable storage media do not include transient signals.

Computing Device 910 may also contain Communications Device(s) 970 that allow the device to communicate with other devices. Communications Device(s) 970 is an example of communication media. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared and other wireless media. The term computer-readable media as used herein includes both computer-readable storage media and communication media. The described methods may be encoded in any computer-readable media in any form, such as data, computer-executable instructions, and the like.

Computing Device 910 may also have Input Device(s) 960 such as keyboard, mouse, pen, voice input device, touch input device, etc. Output Device(s) 950 such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above-described logic and still conform to the described embodiments. Further, operations described herein may occur sequentially, or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples, and data provide a complete description of the manufacture and use of the invention. Since many embodiments of the invention can be made without departing from the spirit and scope of the invention, the invention resides in the claims hereinafter appended.

1. A self-serve food and beverage service stand comprising:
a building structure having a roof, a plurality of walls connected to the roof, an entrance, and an exit;
an information hub displaying instructions, recipes, and ingredient information;
a plurality of housing units containing food and beverage ingredients;
a payment terminal; and
a blending station.

2. The building structure of claim 1 wherein the building structure utilizes a secured access system.

3. The information hub of claim 1 further comprising a means to search for recipes and ingredients based on factors from the list containing ingredient name, recipe name, health conditions, and dietary needs.

4. The information hub of claim 1 further comprising a means of receiving user information from an online profile, health monitoring device, or fitness tracker for purposes of recommending a recipe or ingredient.

5. The information hub of claim 1 further including a health detection device to determine a user's health conditions or dietary needs on-site for purposes of recommending a recipe or ingredient.

6. The plurality of housing units of claim 1 wherein the housing units are refrigerated.

7. The plurality of housing units of claim 1 wherein the housing units are vending machines.

8. The plurality of housing units of claim 1 wherein the housing units dispense containers including some or all ingredients of a standard recipe mix.

9. The plurality of housing units of claim 1 wherein the housing units dispense any food or beverage item from the list containing mixed or blended drinks, mixed or blended foods, juices, whole fruit and vegetable smoothies, bubble tea, coffee, hot chocolate, milkshakes, puddings, custards, purees, sauces, spreads, soups, dairy products, and dairy alternatives.

10. The plurality of housing units of claim 1 wherein the housing units dispense any food or beverage item in packaging containing individually-sealed packets.

11. The plurality of housing units of claim 1 wherein the housing units dispense any food or beverage item in vacuum-sealed containers.

12. The payment terminal of claim 1 wherein the payment terminal is integrated with the housing unit containing food and beverage ingredients.

13. The payment terminal of claim 1 wherein the payment terminal accepts payments of cash, credit cards, rewards cards, tokens, and wireless payments.

14. The payment terminal of claim 1 wherein the payment terminal allows customers to conduct a single payment transaction for items dispensed from multiple food and beverage item housing units.

15. The blending station of claim 1 further comprising at least one blender or mixer.

16. The blending station of claim 1 wherein the blending station is integrated with the housing unit containing food and beverage ingredients.

17. A method for packaging Self-Serve Food and Beverage Service ingredients, comprising:
a single package having dividers separating individual ingredients which together make up a standard recipe mix.

18. A computer operable method of searching for recipes and ingredients, comprising:
performing a search for recipes and ingredients based on an ingredient name, recipe name, health condition, or dietary need;
displaying, on a user interface, a result list of the search;
receiving an input selecting a recipe or ingredient from the result list; and
transmitting user data, recipe selections, and ingredient selections to a self-serve food and beverage dispensing machine.

19. The method of claim 18, wherein the health condition or dietary need refers to information entered by a user.

20. The method of claim 18, wherein a user's health condition or dietary need refers to information from an external source containing information about a user's health conditions or dietary needs.
